(19) United States
(12) Patent Application Publication
(10) Pub. No.: US 2008/0090015 A1
(43) Pub. Date: Apr. 17, 2008

(54) Method and apparatus for pad printing of artificial glass eyes

(76) Inventor: Antonio R. Alfaro, Upper Black Eddy, PA (US)

Correspondence Address: JOHN W. GOLDSCHMIDT, JR. ESQUIRE;DILWORTH PAXON LLP, 3200 MELLON BANK CENTER, 1735 MARKET STREET, PHILADELPHIA, PA, 19103, US

(21) Appl. No.: 11/891,942

(22) Filed: Aug. 13, 2007

Related U.S. Application Data
(60) Provisional application No. 60/837,248, filed on Aug. 11, 2006.

(51) Int. Cl. B05D 1/36

(52) U.S. Cl. 427/413; 427/402; 434/271; 434/295

(57) ABSTRACT

An improved apparatus and method for producing improved artificial eyes is disclosed. The artificial eye comprises a substrate, graphical or decorative inks, and a protective barrier material or layer. Generally, the decorative ink is applied to the inner or convex surface of the substrate, preferably by pad printing techniques. The protective barrier layer may then be applied to the decorative ink layer in order to protect the decorative ink from physical wear, separation from the substrate, chemical reaction, and other degradation. The barrier layer may comprise, for example a rubberized coating, automotive undercoating, paraffin, wax, or other coating sufficient to protect the decorative ink.

### CROSS REFERENCE TO RELATED APPLICATION

This application claims priority to U.S. Provisional Patent Application Ser. No. 60/837,248, filed Aug. 11, 2006, the entirety of which is incorporated herein by reference.

### FIELD OF INVENTION

This invention is directed to an apparatus and method relating to printing inks on smooth, flat, curved and/or uneven surfaces. More specifically, this invention is directed to a method and apparatus for printing inks on substrates, and particularly substrates having surfaces which are not conducive to inks adhering to such surfaces, such as for example, glass and glass-like surfaces used in the production of artificial eyes.

### BACKGROUND OF THE INVENTION

Printing inks on smooth, flat, curved and/or uneven surfaces such as glass and glass like substrates, and permanently adhering inks to such surfaces has long been a problem encountered in the printing arts. In this regard, inks do not readily adhere or remain affixed to such surfaces. In addition, the inks are prone to physical wear, scratching, shrinkage and separation from the substrate, chemical reaction to materials with which the ink comes in contact, and other forms of degradation.

At present, artificial eyes, and particularly artificial eyes of high quality used in taxidermy, are hand painted by highly skilled artisans. These high quality artificial eyes are often made of glass, crystal or other glass-like substrates which are typically decorated with paints or inks comprising fritted enamels. Once applied to the substrate, the inks are fired into the glass using ovens operating at high temperatures. The firing process causes the enamels to become affixed to the glass substrate, and bonds the enamel to the glass creating a very durable combination of enamel to substrate.

Although effective, the manual application of these enamels is labor intensive, and thus time consuming and costly. Unfortunately, enamels used on glass-like substrates are not conducive to automated application methods. Upon initial consideration, established pad printing techniques might appear to be a suitable choice in automating the process of applying inks to glass-like substrates. However, as explained below, pad printing techniques, are not easily adapted to the automated printing of inks on glass. Before addressing such problems, however, a brief description of the general principals of pad printing is warranted.

Pad printing is a method of printing designs or text onto flat, curved, or uneven surfaces. Pad printing may be accomplished with a semi-automatic or fully automated machine. See, for example, the Printex, Inc. pad printer shown at A-49, A-56, and A-57 of Appendix A attached hereto. First a photopolymer or steel plate is etched with the design to be transferred creating a series of depressions in an otherwise flat plate in order to hold the ink to be transferred in the pattern of the design. A cup filled with a pad printing ink is placed over this design. This cup has a flat edge which contacts the plate evenly so that when the cup is moved laterally across the plate, a squeegee effect is created, keeping all the ink in the cup save that which was deposited in the valleys and depressions etched into the plate. A silicone pad is then positioned over the image and pressed down upon it. The ink is engineered to stick to the pad and stay in the shape of the design. The same pad is then positioned over the substrate one wishes to print and then is pressed down upon it. The ink then releases from the pad onto the substrate. These specially engineered inks, the machines, and the silicone pads are available to the public and generally known to the printing industry.

Though pad printing inks are specially engineered to adhere to a silicone pad only well enough to travel to a substrate and have a tendency to transfer to any substrate other than silicone more readily, printing on glass tends to be problematic. Glass in an extremely smooth surface, thereby offering little or no surface area to which the ink may be affixed. By contrast, however, substrates such as plastic or paper, for example, provide a more textured surface to which inks may adhere.

Pad printing techniques have been employed with some success in the production of a plastic eyes used in taxidermy. In this regard, it is believed that pad printing has been used in the production of plastic artificial deer eyes. With plastic substrates, adhesion of the ink is more easily achieved and no catalyst or baking is necessary. Though printing on plastic substrates may avoid many of the problems of printing on glass substrates, plastic has other significant drawbacks as a substrate particularly with when used in the manufacture of artificial eyes. Perhaps most significant of such drawbacks is that plastic eyes are not very durable. Specifically, the plastic itself is easily scratched, harmed by chemicals, and prone to problems with clarity due to inherent imperfections in the plastic substrate. In contrast, for many applications, glass substrates are far superior to plastic inasmuch as glass remains clear and does not cloud, does not easily scratch, and is highly resistant to chemicals.

Although glass is a preferred substrate in many applications, known pad printing techniques are not well suited to the automated application of inks to glass-like surfaces. In this regard, the inks do not adhere well to smooth glass-like surfaces. The inks are susceptible to: (1) physical wear and scratching; (2) chemical reactions to other materials with which the ink may come in contact; and (3) other forms of degradation. For example, cleaning solvents and acidic based materials, such as mounting clays used in taxidermy to mount artificial eyes to taxidermy manikins, tend to weaken the already weak bonds between the inks and glass-like substrate.

Even when the pad printing inks are mixed with a glass hardening catalyst and heat cured, the inks may not sufficiently adhere to the inside surface of the glass eye. Accordingly, when epoxies or other adhesives are used to affix the glass eye to a manikin or other form, the epoxies or other adhesives tend to shrink causing the inks to “delaminate” from the glass substrate inasmuch as the bond between the ink and epoxy is stronger than the bond between the ink and the glass. In addition, where acidic mounting clays are used in mounting the eye to a manikin or other form, such clays may come in contact with the inks. In many instances, the inks are not able to withstand the acids which may leach from the clays. Furthermore, a taxidermist may use lacquer thinner or acetone during the mounting process to clean unwanted clay or paint from the outside of the eye. Use of such solvents may seep to the inside of the eye causing degradation of the printed inks.

Thus, artificial glass eyes are exposed to more rigorous treatment and environments than other painted or printed products. Artificial glass eyes may be used in a number of applications such as doll making, sculpture, and taxidermy, a particularly harsh application for glass eyes.

For example, in the process of mounting artificial eyes in taxidermy applications mentioned above, a taxidermist typically sets a glass eye into a form or taxidermy manikin by filling the inside of its hemispherical shape with clay or a two part epoxy. The same clay or epoxy is also used to sculpt an anatomically correct eyelid area over the eye for the animal hide to lay over the eye in a natural way. A layer of hide paste is then applied to the surface of the manikin. The hide of the animal is then pulled over the form with eye set in, positioned properly, seems are sewn and it is left to dry. This is the bulk of the labor involved in most taxidermy and once it is left to dry, any adjustments to eye set are very difficult and more labor intensive than the original setting of the eye.

If one were to produce an eye using a pad printer and the specialized inks for the process described herein, the inks printed on the glass substrate may not withstand the rigors of the taxidermy eye mounting process described above. For example, certain mounting clays have a mild acidity which would attack the inks causing them to dissolve and discolor. This is particularly a problem when the clay is first applied and is drying. If a taxidermist inadvertently uses acidic clay, the acids may discolor the printed eye. Even though many taxidermists utilize pH neutral (not acidic or basic) clay, some batches of such clays contain trace acidity which may contain enough acid to adversely affect the inks.

In addition, epoxies are also widely used in the eye mounting process. The epoxies, which are applied to and/or come in contact with the inks, tend to shrink as the epoxy sets. The shrinkage of the epoxy puts a tremendous amount of pressure on the surface of the decorative ink layer and, in at least some cases, the ink may delaminate from the concave surface of the glass substrate. In severe cases, the glass eye may fracture as a result of epoxy shrinkage.

One option may be to apply a hard coating adhered to the ink layer with an epoxy or other adhesive. However, hard coatings have a tendency to aid in delamination by spreading the pressure caused by epoxy shrinkage over the inside surface of the glass eye substrate thereby pulling the ink off of the glass surface.

Another option may be to apply a hard backing, such as for example, a flat plastic disk affixed to the back or the concave surface of the glass eye substrate. However, the fabrication and application of such a disk would prove difficult and costly. In one embodiment, the disk would be adhered to the edge of the glass eye, which is often a thin edge, thereby providing little surface area for adhesion. Thus, the disk may detach from the edge of the glass eye, or not be affixed properly, leaving the ink layer exposed to harmful effects and agents.

At present, no solution to these problems has yet been devised. Accordingly, there exists a need to automate the process for applying inks to glass and glass-like substrates such that: (1) a substantially anatomically correct likeness of an eye found in nature is produced by the printing process; (2) the inks are consistently and repetitively applied to multiple artificial glass eyes; (3) the inks are easily applied to and substantially completely release from ink application devices; and (4) the inks substantially completely and permanently adhere to glass-like substrates making it less likely that the inks will to shrink, separate, wear scratch, and/or react with other materials.

Thus, there exists a need for an apparatus and method for automating the process of printing inks on glass and glass-like substrates which will improve the adhesion of inks to glass substrates, and are more durable when used in taxidermy and other applications.

### SUMMARY OF THE INVENTION

The difficulties encountered in applying and adhering printing inks to glass substrates may be, in part, overcome by using specially formulated inks with a specially adapted pad printing machine. In this regard, a hardener catalyst and thinner may be added to a printing ink to produce a pad printing ink. The catalyst is preferably an air drying catalyst. The resulting pad printing ink readily and completely releases from the pad of the printing machine, and transfers and adheres to the ink to the glass substrate. See, for example, A-45 through A-48 of Appendix A. The ink may then be cured in an oven to assist in the drying and adherence of the ink to the glass substrate.

In this regard, the ink may be dried on the glass at about 180 degrees Fahrenheit. The printed glass is then ready to be used for its intended purpose such as, for example, as coffee cups, plates, and the like. After curing, the inks will not easily come off in a dishwasher or by touching or rubbing. However, the inks may still be scratched off with an implement such as a knife. The inks may also be removed from the glass surface by emersion in or rubbing with a solvent such as acetone.

Thus, the problem remains that, even after the pad printing ink is applied to the glass substrate, the ink may still be susceptible to physical wear, scratching, delamination, or exposure to solvents, chemicals, or other materials. One solution to this problem is to create a barrier between the inks and the sources of wear, chemicals or other materials which may come in contact with the inks. The barrier may comprise any substance, such as for example a rubberized material, which may be applied directly or indirectly to the ink layer such that the ink is protected from physical wear, delamination, or exposure to solvents or other chemicals which may cause degradation of the inks.

### BRIEF DESCRIPTION OF THE DRAWINGS

Understanding of the present invention will be facilitated by consideration of the following detailed description of the embodiments of the present invention taken in conjunction with the accompanying drawings, in which like numerals refer to like parts, and wherein:

FIG. 1 is a plan view of the top, convex surface of an embodiment of the artificial eye of the instant invention;

FIG. 2 is a plan view, opposite that of FIG. 1, of the concave surface of the artificial eye of FIG. 1;

FIG. 3 is an elevation of the artificial eye of FIG. 1; and

FIG. 4 is a cross section of the artificial eye of FIG. 1 taken through 4-4 of FIGS. 1 and 2.

FIG. 5A and FIG. 5B combined is a flow diagram of an embodiment of the method of the instant invention.

Additional documents attached hereto constitute additional teachings included in the present invention, including Appendix A hereto comprising photographs which depict an embodiment of the instant invention, and which are incorporated by reference in there entireties herewith.

### DETAILED DESCRIPTION OF THE EMBODIMENTS

It is to be understood that the figures and descriptions of the present invention have been simplified to illustrate elements that are relevant for a clear understanding of the present invention, while eliminating, for the purposes of clarity, many other elements which may be found in the present invention. Those of ordinary skill in the pertinent art will recognize that other elements are desirable and/or required in order to implement the present invention. However, because such elements are well known in the art, and because such elements do not facilitate a better understanding of the present invention, a discussion of such elements is not provided herein.

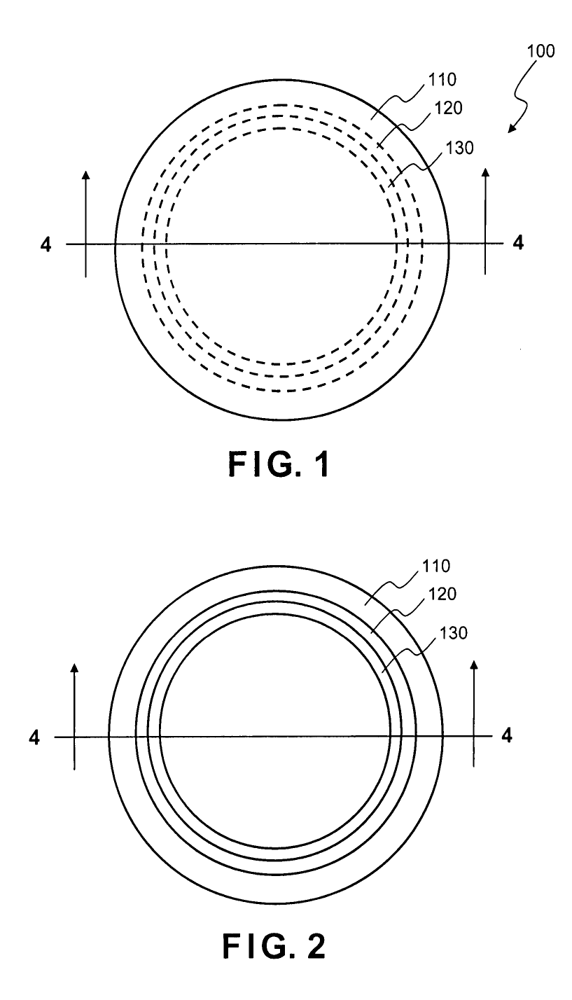

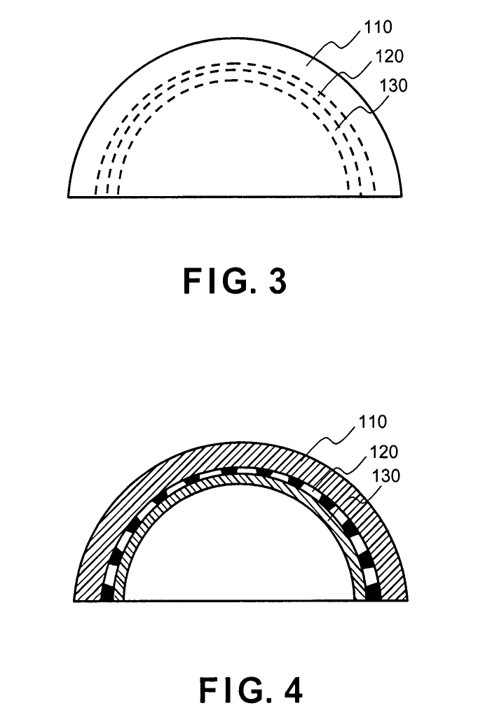

Turning now to FIGS. 1 through 4, there is shown artificial eye 100. Eye 100 comprises substrate 110, graphical or decorative ink 120 and barrier material 130. Generally, decorative ink 120 is applied to the inner or convex surface of substrate 110, preferably by pad printing techniques. Barrier Layer 130 may then be applied to decorative ink 120 in order to protect decorative ink 120 from physical wear, separation from substrate 110, chemical reaction, and other degradation. Barrier layer 130 may comprise, for example a rubberized coating, automotive undercoating, paraffin, wax, or other coating sufficient to protect decorative ink 120.

Optionally, one or more additional ink and/or barrier layers may be added to eye 100 depending on the particular application. For example, a layer of background ink, preferably a vinyl background ink (not shown) may be incorporated between decorative ink 120 and barrier layer 130.

As described above flexible barrier coating 130 designed to protect decorative inks 120 from physical wear, separation from substrate 110, chemical reaction, and other degradation. Barrier coating 130 may be made out of a rubberized material which may be applied to artificial eye 100 by hand or by spraying methods. One type of coating which may be employed as barrier coating 130 is automotive undercoating which is generally available at hardware and automotive repair stores.

Barrier layer 130 may be particularly effective in protecting decorative inks 120 from the compounds and other materials used in mounting artificial eyes 100, particularly in taxidermy applications. As described above, clays containing even trace amounts of acid are often used in mounting artificial eyes 100 in taxidermy and other applications. The acids, even in small amounts, react with the inks to dissolve, discolor, or otherwise distort the image created by decorative inks 120. Where barrier layer 130 is employed, acids will come in contact the protective coating, rather than contact decorative ink 120 while the clay is drying and thereafter. Accordingly, barrier layer 130 protects decorative inks 120 from the effects of the acid.

Barrier layer 130 is also particularly effective where epoxies are used in the mounting process. As described above, epoxies also tend to shrink as the epoxy dries thereby pulling on and “delaminating” decorative inks 120 from glass substrate 110. Where barrier layer 130 is employed, the epoxy will tend to pull at barrier layer 130, which may comprise a rubberized coating, as the epoxy sets and shrinks. In this regard, barrier layer 130 will readily move and separate from decorative ink 120, equalizing the stress on the surface of glass substrate 110, and thereby preventing decorative ink 120 from delaminating from glass substrate 110. More than just protecting decorative inks 120, barrier layer 130 also prevents breakage of glass substrate 110 caused by the stresses introduced with the expansion and contraction of glass substrate 110 when exposed to hot and cold ambient or other temperatures.

Barrier layer 130 may be comprised of almost any rubberized or other flexible and/or protective coating suitable to the particular application. However, certain coatings are more readily available in forms that are more easily applied and/or cost effective.

For example, silicone rubber is available in a spray system which requires the purchase of a special sprayer. Silicone has a short set up time of one hour and very good resistance to solvents, but generally silicone does not adhere well to most materials. Silicone rubber may work effectively as barrier layer 130 provided that sufficient adhesion is obtained to ensure that the silicone rubber will remain on artificial eye 100 until artificial eye 100 is set in place on the manikin or other form.

Urethane rubber is also available in the same type of spray system as silicone. Although urethane rubber has better adhesion than silicone, urethane is less resistant to chemicals. In addition, the set up time for urethane is typically two to three hours.

Butyl rubber is also an option for barrier layer 130 and may be obtained in a sprayable form, however, butyl rubber is not very resistant to chemicals.

EPDM (ethylene propylene diene monomer) rubber is available in a sprayable form and has excellent resistance to keytone solvents, alcohol, and acids up to about 50% concentration. EPDM rubber may withstand temperatures between about −60 and about +300 degrees Fahrenheit. EPDM rubber does, however, have a very slow cure time and requires the purchase of very expensive spray application equipment. Furthermore, EPDM rubber is commonly available in five gallon drums which must be used within five hours of opening. In certain instances, this would potentially result in significant waste, making EPDM a cost prohibitive material, albeit a potentially effective one.

Fluoroelastomers are a synthetic range of rubbers available in spray form. Fluoroelastomers have exceptional resistance to chemicals with the exception of low molecular weight keytones and esters such as Methyl Ethyl Keytone, and Acetone. However, in many instances, only prolonged contact or rubbing with such chemicals will adversely react with a fluoroelastomer barrier layer 130. In addition, fluoroelastomers have a very fast cure time (generally less than one hour) and bond well to glass. Fluoroelastomers also boast a long shelf life of about one year, and may withstand temperatures of between about −40 and about +400 degrees Fahrenheit, with short spikes to about +500 degrees Fahrenheit. Thus, in many applications, fluoroelastomers may represent an excellent choice for barrier layer 130. In addition, fluoroelastomers are readily available in spray form, including but not limited to in aerosol cans, and, thus, do not require specialized equipment for application.

Rubberized automotive undercoating is also a readily available alternative material and demonstrates sufficient resistance to make it a viable choice as barrier layer 130. While automotive undercoating does not demonstrate superior chemical or temperature resistance, it does adhere well to the inside of glass substrate 110 and does not adversely react with decorative inks 120, thus creating a very flexible barrier layer 130. Automotive undercoating is also less expensive than many other rubber coatings.

Also, a sprayable mold release, a sprayable wax, or a wax mold release material may be used as barrier layer 130. Such materials are readily available and provide good barrier characteristics. However, it should be noted that certain sprayable mold releases, sprayable waxes, and wax mold releases may be removed by physical rubbing or solvents.

Each of these coatings is exemplary of some acceptable options for materials which may be used in the instant invention for barrier layer 130 making it possible to pad print artificial glass eye 100. Each alternative coating has its positive and negative aspects. Ultimately the choice of coatings must be made based upon the intended application and the composition of glass substrate 110 and decorative inks 120. In taxidermy applications, for example, automotive undercoating may suffice as barrier layer 130, however a fluoroelastomer may offer improved barrier characteristics as well as a more aesthetically pleasing finished product. In the artificial glass eye and other specialized applications, which are far too numerous to recite, choice of barrier layer material 130 may be based upon various factors including, but not limited to: (1) the temperature level which glass substrate 110 will be exposed; (2) the type of chemicals, acids, or other materials which glass substrate 110 may contact; (3) the pressure to which decorative inks 120 may be exposed as a result of shrinking epoxies or other adhesives; (4) cost; and/or (5) ease of application of the selected material.

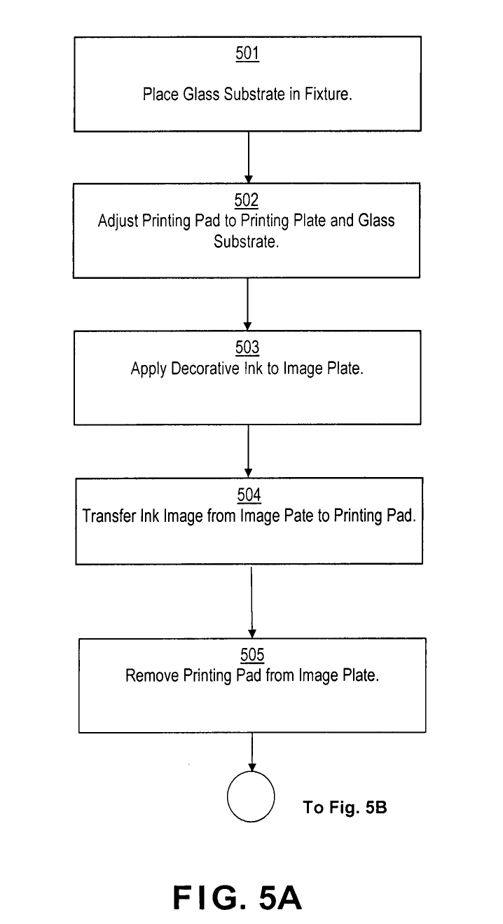

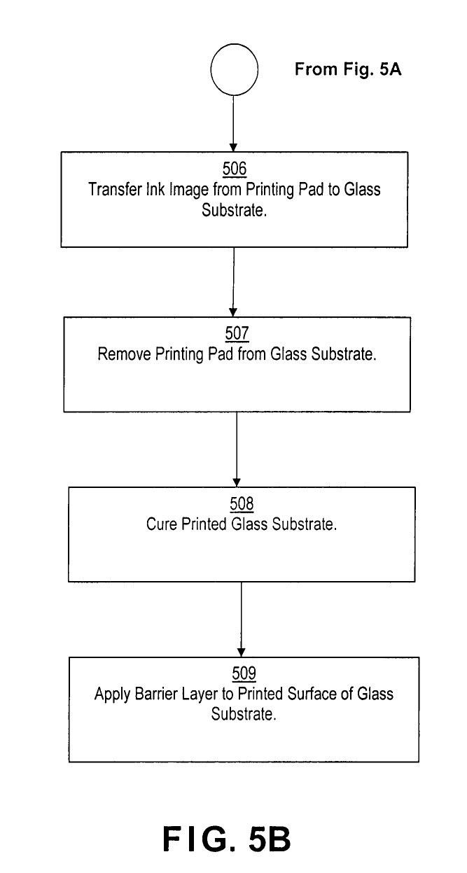

One embodiment of the process of printing artificial eye 100 is depicted in the flow chart of FIG. 5. Reference may also be made to A-65 through A-71 of Appendix A. The steps of the process may be described as follows. In order to effectively pad print on glass substrate 110 with a printing pad, a fixture must be made to hold substrate 110. See A-65. In the case of an artificial glass eye as substrate 110, the preferred way to hold the glass eye is upside down with the concave side up in the fixture which may preferably employ a vacuum to hold glass substrate 110. See A-65. The vacuum may employ a rubber seal in the fixture to maintain the vacuum between glass substrate 110 and the fixture. See A-65. An etched image plate bearing the image to be printed and decorative inks 120 are also prepared. See A-1 through A-44.

Thus, in step 501 of FIG. 5, glass substrate 110 is placed and held in the fixture. See also A-65. In step 502, the relative position of the printing pad is adjusted relative to the position of glass substrate 110 and the etched image plate. See also A-66. Decorative ink 120 is applied to the image plate in step 503. See also A-67. In step 504, the printing pad is placed in contact with the image plate bearing decorative ink 120, thereby transferring the inked image from the image plate to the printing pad. See also A-68. The printing pad is then removed from the image plate bearing the transferred ink image in step 505. See also A-69. The image bearing printing pad is then placed in contact with the surface to be printed of glass substrate 110, thereby transferring the ink image to substrate 110 in step 506. See also A-70. The printing pad is then removed from glass substrate 110 in step 507. See also A-71. In step 508, printed glass substrate 110 is cured, preferably in a laboratory grade oven to facilitate drying, hardening, and adherence of decorative inks 120 to glass substrate 110. See also A-74. Finally, in step 508, protective barrier layer 130 is applied to the printed surface of glass substrate 110. See also A-75 and A-76.

It is not necessary to use an automatic machine in practicing the process of this invention, however, such automation is preferred inasmuch as the overall process is simplified and greatly increases consistency of the application of the inks to glass substrate 110. Although it is not necessary to use a two color machine, such a machine is preferred because it tends to simplify the process increases consistency. For the purpose of this non-limiting example, a two color automatic “cup style” pad printing machine will be referenced, such as the machine depicted at A-49.

This embodiment of the machine uses two separate ink cups attached to one assembly that moves back and forth to squeegee ink over two separate image plates. This same assembly also has two separate printing pads attached to it that move up and down together in order to pick up ink from the designs on the image plates.

One eye is loaded in the holding fixture. The pad/cup assembly is moved back so that the two cups squeegee ink over the two image plates. When this assembly is at its full rear position, the two pads are situated over the images. Some manual adjustment to the pad mounting is necessary in order to ensure that they are directly centered over the image that is etched in the plate. The pads are pressed down upon the etched areas of the plate which now have ink deposited in them. When the pads come back up to their resting position, the designs are visible on the pads from the ink that has just been transferred to them. The pad/cup assembly then is moved forward to its original position. At this time, the pads are situated over the substrate to be printed. The holding fixture is positioned under the first design to be printed. Again, some manual adjustments are necessary to ensure that it is directly under the pad. The pads both are pressed down, but only the pad with the first design contacts the eye. The holding fixture is then shuttled over so that it is positioned under the other pad. Both pads are again pressed down so that the second design is deposited over top of the first design. Some manual adjustment are made separately here to ensure proper positioning of the holding fixture to ensure that the second design is printed in proper alignment with the first design.

Though this process is relatively straight forward, an image plate must be properly etched, inks properly mixed, and adjustments to the process preferably made depending on the eye being printed, ambient temperature and humidity, and the types of designs being printed. These processes will be addressed in further detail, in the example of printing a basic deer eye with a pupil, iris detail, and no white sclera area. See A-1 to A-44 of Appendix A.

First, the image plates must be processed. The artwork is produced depicting the designs to be printed. The design should be separated into the different colors that will be printed. A typical four color process can be used along with a four color printing machine, but other combinations of processes and machines may be employed. Artwork may be produced by hand or by computer. It is preferable that the artwork is opaque. Artwork should also be made or printed on special clear film.

The pupil of a deer eye is actually a void and has no color, but what is generally seen in this area is a blackish blue due to reflection of the retina behind the pupil. The pupil is a substantially oval shape and has no noticeable details within that need to be reproduced in an artificial eye. For this image all that is needed is a simple, solid, opaque oval shape like that found in the natural eye.

The iris of the deer eye contains many components. There is a pattern in the iris that radiates from and surrounds the pupil in an elliptical pattern. See A-3 through A-4. There is also dark shading around the pupil and a dark shading at the edge of the iris called the limbus band. See A-3 through A-4. The pattern may be separated from the shading into two separate designs if one is using a three or four color machine. This pattern is easier to produce in that it is difficult to successfully etch a plate that has solid art (i.e. darkest part of shading), and half-tone art (i.e. stippling and random patterns that fade). With experience and careful management of the artwork, these aspects can be combined into one image plate making it unnecessary to have more than two printing steps. See A-5 through A-9.

The pupil artwork is positioned over the image plate in the proper position. This position is unique to the machine being used. The pupil and artwork is laid into an ultra-violet exposure unit and vacuum is employed to keep the artwork pressed against the plate. See A-24 and A-25. They are then exposed to light for approximately eighty seconds. See A-28 through A-33. The artwork is then removed and a 300 line screen is placed over the plate. See A-34 and A-35. Vacuum is again used to keep the line screen pressed against the plate. See A-36. This is then exposed to UV light for approximately thirty seconds. See A-37. The plate is then removed from the exposure unit and placed into an alcohol solution available from the printing supplier and agitated gently by rocking the container for seventy seconds. See A-38 and A-39. A simple Tupperware style container can be used for this. See A-38 and A-39. After the agitation period, while the plate is still in the alcohol solution, it is brushed very gently in a figure eight pattern for twenty seconds. Se A-40. The brush used is a house painting edger. See A-40. The plate is then removed and rinsed with warm water and brushed lightly under this warm water to remove any residual photopolymer material. See A-41. The plate is then dried either gently with a soft cloth or by blowing with moisture free compressed air. It is placed in an oven at about 180 degrees F. for ten minutes to completely dry it. See A-42. Once this is finished and the plate is allowed to cool, it is placed in the exposure unit again and exposed to UV light for approximately ten minutes to totally harden the photopolymer material. See A-43. The image plate is now ready to use. See A-44.

The iris artwork should be sent to a professional printer to be output by an image setter. It is recommended that the halftones are not less than about 30% output and not more than about 80% output. A preferred range of halftones when printing on glass is between about 55% and about 90%.

Halftone artwork is processed differently than solid, opaque artwork (100% output). Because halftone artwork is already broken up into a series of dots, a line screen is not necessary. The artwork is placed in the proper position on the plate. See A-24 and A-25. Vacuum is used to hold everything in place and it is exposed to UV light for approximately eighteen seconds. See A-27 through A-37. It is removed from the exposure unit, placed in the alcohol bath and agitated for about sixty seconds, brushed for about fifteen seconds, and then rinsed under warm water, brushing lightly. See A-38 through A-41. The plate is then dried in the oven at about 180 degrees F. for about ten minutes and exposed to UV light for about ten minutes just the same as the pupil plate. See A-42 through A-44.

All of the exposure techniques described above are subject to change depending upon the type of plate being used. It is also best to work in a dark room environment to avoid over exposure of the plate to UV light during positioning of the artwork and other handling between steps.

Once the plates are processed and ready to use, the inks are mixed. By way of non-limiting example, the components which may be used in the formulation of the ink compounds, used in connection with the pad printing of the glass eye substrate of the present embodiment, are shown at A-45 through A-48 of Appendix A. In the present embodiment, such components may be employed in mixing the pad printing inks which are to be used to print the details of the deer eye.

When mixing and using the inks, it is important to control the ambient temperature and relative humidity. Ideal conditions are approximately 72 degrees Fahrenheit with a relative humidity of between about 30% to about 50%. Under these conditions, the pupil color (in this embodiment, a dark, blackish blue) may be mixed on an accurate gram scale starting with at least about 20 g of ink, such as for example, Black Colormatic TCP 9902 M ink available from Printex. A special glass hardener, such as for example, Glass Hardener No. 5 available from Printex and shown in A-45 and A-48 of Appendix A, is added at about twenty percent (20%) of the ink by weight. A fast drying thinner then is added at about thirty percent (30%) by weight of the ink/hardener mixture. For example, starting with about 20 g of ink, about 4 g of glass hardener is added to the ink. Then, about 7.2 g of fast drying thinner is added to the 24 g ink/hardener mixture.

The black colored ink for the iris details of this embodiment of the invention are generally mixed differently for two reasons. First, the printed iris details comprise a half-tone design. Accordingly, the ink should be thinner in order to flow into the fine details of the printing plate. Second, the ink for the iris should be thinner inasmuch as the iris ink will be the second color to be printed, and will remain on the printing pad for a longer period of time before it is deposited on the glass eye. Thus, the ink should be mixed with a slow drying thinner at about thirty-five percent (35%) of the volume of the ink and hardener mixture. In this embodiment, there is no change to the other ink mixture ratios.

Turning now to A-49 through A-76 there is shown an embodiment of the apparatus and method of the invention for printing a single ink on a two color pad printing machine. First, an image plate is placed onto a magnetic base plate with alignment pins to hold the image and base plates (collectively referred to herein as the “printing plate assembly”) in the proper position. See A-50 and A-51. The ink is then poured into an ink cup, and the cup is placed on the surface of the image plate. See A-52 through A-55. The ink cup has very powerful magnets that hold the cup against the surface of the image plate. See A-52. The printing plate assembly together with the ink cup mounted on the surface of the image plate is collectively referred to herein as the “ink cup/printing plate assembly.” Preferably, the image plate comprises a non-ferrous material with a ferrous steel backing. See A-50 and A-51. The ink cup/printing plate assembly is placed in the pad printing machine, as shown in A-58 and A-59. The ink cup/printing plate assembly is held in place with a large chuck alignment pin shown in A-60. The chuck pin is placed through a mounting hole in a shuttle mounting bracket of the pad printing machine (as shown in A-61), and into a mounting hole in the center of the cup (as shown in A-62), such that the cup may slide with a “squeegee effect” over the surface of the image plate to deposit ink in the image (as shown in A-63).

Printing pads, such as the pad shown in A-50, are selected such that the pad will fit into the inside of the eyes being printed. A pad with a substantially conical shape which has a slightly more acute angle than the inside concavity of the glass eye substrate is preferred. Additionally, the pad preferably comprises a harder durometer silicone, at or about a 45 on the Shore 00 scale. In the two color pad printing embodiment of the invention, both pads preferably have substantially the same characteristics.

The ink pad is then mounted on the shuttle mounting bracket to which the ink cup is mounted, such that the ink pad moves or “shuttles” linearly the same distance which the ink cup moves or “shuttles” as the cup applies ink to the image plate. The shuttle mounting bracket is then shuttled toward the rear of the machine to a rear position. See A-63. The ink pad is then adjusted so that the pad is centered over the design etched in the image plate. See A-64. The assembly is then shuttled forward and the substrate holding fixture is adjusted so that the pad is directly over the glass eye, which glass eye is positioned in the substrate holding fixture. See A-65. The glass eye preferably is held in place by a vacuum in the substrate holding fixture. See A-65. Adjustments to the relative positioning of the printing pad to the glass eye substrate may be made by moving an ink/pad assembly table (shown at A-66 of Appendix A) upon which the substrate holding fixture is moveably mounted.

In the two color embodiment of the invention, the substrate holding fixture is then shuttled over to a second color position. The second color position is situated adjacent to the first color position in the pad printing machine. In the view shown in A-67, the second color position is the area to the left (as one looks at the page) of the first color position (which, for illustrative purposes, the second position is present but not shown with an ink cup, printing plate assembly, or printing pad in the photographs of Appendix A). In the two color embodiment, the second color position is equipped with an ink cup, printing plate assembly and printing pad. As in the first color position, the ink cup and printing pad are mounted to the shuttle mounting bracket. Thus, the elements of the second color position are similar to those of the first color position, except that the printing plate may be etched with a different design and/or a different color ink may be used.

In the case of the glass deer eye embodiment of the present invention, typically, the pupil is printed in the first color position, and the iris is printed in the second color position. Adjustments to the printed images, including, but not limited to, printed image location on the glass substrate and color registration, are then made to the ink/pad assembly table so that when the fixture shuttles over to the second color position, the fixture is located directly under the second pad. Test prints may be made in order to make fine adjustments to the alignment of the printing pads relative to the glass eye substrate, and the registration of the two printed images relative to each other. After the preprinting adjustments are completed, the pad printing machine may be cycled automatically or manually to begin printing.

Turning now to A-67 through A-71 of Appendix A, there is shown an embodiment of a two color pad printing machine which is set up for a single color only. In this embodiment, the iris is being printed to illustrate the detail which may be attained by the process of this invention. After the glass eye substrate is positioned on the vacuum substrate holding fixture, the shuttle mounting bracket is: (1) moved toward the rear of the machine as the ink cup applies ink to the image plate; and (2) the pad is positioned over the inked image on the image plate in the first step in printing cycle of the pad printing machine. See A-67. Next, with the pad positioned over the inked image, the pad moves down to contact the inked image as the ink is transferred from the image to the pad. See A-68. As the pad moves upward and away from the image plate, the transferred ink substantially retains the form of the image on the pad. See A-69. The pad then moves to a forward position over the glass substrate while the ink cup also moves forward over the image to deposit ink for the next pad printing cycle. See A-69. The pad then moves downward to transfer the ink image to the glass substrate. See A-70. The pad then moves upward and away from the glass substrate, with the ink image being completely transferred to the glass substrate, provided that the ink is mixed in accordance with the invention. See A-71. The pad then moves to the rear position over the inked image to begin the process cycle for the next glass substrate to be printed.

A-72 and A-73 are views of the printed glass substrate which show the detail which may be attained by the process of this invention. If the glass deer eye shown were being printed, the glass eye would be subject to a two color printing process where a dark blue pupil would have been printed in the first color position, while the iris would have been printed in the second color position.

After printing, the printed glass substrate may be cured in a laboratory or other appropriate oven at about 180 degrees Fahrenheit for thirty (30) minutes, to preferably about 350 degrees Fahrenheit. See A-74

Finally, a protective barrier layer may be applied over the printed inks. See A-75. An automotive undercoating or other rubberized material may be used. The barrier layer may be applied by any appropriate method including but not limited to inserting the printed glass eye substrate to a skin wrap and spraying on the barrier layer. See A-75 and A-76.

In certain embodiments, pad printing may produce a glass eye with substantially all of the graphics required, however, it may be advantageous to apply additional graphical ink layers though other methods. For example, although the finished graphical coloration of the glass deer eye of this embodiment may be achieved by using a three or four color machine having three or four pads and ink cups, alternatively, the glass eye may be produced more rapidly by applying the last color with a spray apparatus. In the case of the glass deer eye, the last color is simply a background color that is affected in various tones by the shades of gray produced in the iris detail. In this regard, the eyes may be mounted in a fixture to keep the sprayed ink from being deposited on the front of the eyes. This fixture may be made of any solid sheet of material having holes drilled or otherwise formed therein, where the holes are slightly smaller than the diameter of the eye. The eyes may then be positioned in the holes with the concave surface of the eye exposed. The ink is then sprayed onto the concave surface of the glass eye. The ink utilized in this spraying process may be the substantially the same type of ink used in the pad printing process, and mixed with substantially the same percentage of glass hardener, but generally thinned by about at least 50% in order to facilitate spraying. Thus, the proportion of thinner used with the ink substantially depends upon the spray apparatus being used.

After application of the graphical inks, the glass eyes may be cured by baking the glass eyes at about 180 degrees F. for between about twenty to about thirty minutes in order to completely dry and harden the inks onto the glass. See A-74. Preferably, in connection with some embodiments of the glass eyes of this invention it has been noted that the inks appear to be much more durable if the glass eyes are baked at about 350 degrees F. for thirty minutes. See A-74. Generally, a laboratory oven is needed to cure the ink. See A-74.

After the glass eyes are cured, the glass eyes may be put into the same spray fixture described above. See A-75 and A-76. Rubberized or other protective barrier coating described herein, such as for example, automotive undercoating or other appropriate material, may be applied by spraying or other appropriate technique. See A-75 and A-76. The barrier coating is then permitted to dry for an appropriate period of time based upon the characteristics of the barrier coating material employed. Once the barrier coating has dried, the glass eyes may be removed from the spray fixture and are ready for use in taxidermy, sculpture or other desired application.

The techniques described herein are based upon the disclosed deer eye. Other types and sizes of glass eyes used in taxidermy as well as other applications may require different selections of ink, mixtures of ink, artwork, plate exposure times and techniques, as well as adjustments to the settings of the machine (i.e. double printing of each design for increased opacity, and the like). However, preferably a barrier coating is applied at the end of the process in order to ensure durability, particularly when there is the potential that the glass eye may be exposed to cold or hot environments, acidic clays, epoxies, or other materials which will tend to shrink when such material hardens, or otherwise degrade the quality and clarity of the graphics printed, or otherwise applied to, the glass eyes.

The disclosure herein is directed to the variations and modifications of the elements and methods of the invention disclosed that will be apparent to those skilled in the art in light of the disclosure herein. Thus, it is intended that the present invention covers the modifications and variations of this invention, provided those modifications and variations come within the scope of the appended claims and the equivalents thereof.

What is claimed is:

1. An artificial eye comprising:
a glass or glass like substrate having substantially concave and convex surfaces;
a layer of decorative ink applied to said concave surface of said substrate, wherein said decorative ink layer has an inner surface and an outer surface; and
a barrier layer applied to said outer surface of said decorative ink layer, wherein said barrier layer substantially protects said decorative ink from physical wear, separation from said substrate, chemical reaction or other degradation.

2. The artificial eye of claim 1, wherein said substrate substantially comprises crystal.

3. The artificial eye of claim 1, wherein said decorative ink comprises pad printing ink.

4. The artificial eye of claim 1, wherein said decorative ink is applied by pad printing to said concave surface of said substrate.

5. The artificial eye of claim 1, wherein said decorative ink layer is in a form which substantially resembles an eye.

6. The artificial eye of claim 1, wherein said artificial eye substantially resembles an eye of an animal.

7. The artificial eye of claim 1, further comprising a layer of background ink applied between said decorative ink and barrier layers.

8. The artificial eye of claim 1, wherein said barrier layer comprises a rubberized coating.

9. The artificial eye of claim 1, wherein said barrier layer comprises automotive undercoating.

10. The artificial eye of claim 1, wherein said artificial eye is mounted to a form used in taxidermy.

11. A method for producing an artificial eye, said eye comprising a glass or glass like substrate, said substrate having substantially concave and convex surfaces, wherein said method comprises the steps of:
applying a layer of decorative ink to said concave surface of said substrate, wherein said decorative ink layer has an inner surface and an outer surface; and
applying a barrier layer to said outer surface of said decorative ink layer, wherein said barrier layer substantially protects said decorative ink from physical wear, separation from said substrate, chemical reaction or other degradation.

12. The method of claim 11, wherein said substrate substantially comprises crystal.

13. The method of claim 11, wherein said decorative ink comprises pad printing ink.

14. The method of claim 11, wherein said decorative ink is applied by pad printing to said concave surface of said substrate.

15. The method of claim 11, wherein said decorative ink layer is in a form which substantially resembles an eye.

16. The method of claim 11, wherein said artificial eye substantially resembles the eye of an animal.

17. The method of claim 11, further comprising the step of applying a layer of background ink between said decorative ink and barrier layers.

18. The method of claim 11, wherein said barrier layer comprises a rubberized coating.

19. The method of claim 11, wherein said barrier layer comprises automotive undercoating.

20. The method of claim 11, wherein said eye is mounted to a form used in taxidermy.

21. A method for printing inks on the surface of an artificial eye, comprising the steps of:
transferring said ink in the form of an image from an image plate to a printing pad;
transferring said ink image from said printing pad to said surface of said eye; and
applying a protective barrier layer to said printed surface of said eye.

22. A method for printing inks on glass or glass like surface comprising the steps of:
transferring said ink in the form of an image from an image plate to a printing pad;
transferring said ink image from said printing pad to said surface of said glass-like surface; and
applying a protective barrier layer to said printed surface of said glass-like surface.
